(19) United States
(12) Patent Application Publication
(10) Pub. No.: US 2023/0070478 A1
(43) Pub. Date: Mar. 9, 2023

(54) IMAGE PROCESSING DEVICE, IMAGE PROCESSING METHOD, AND NON-TRANSITORY COMPUTER READABLE MEDIUM

(71) Applicant: FUJIFILM Business Innovation Corp., Tokyo (JP)

(72) Inventor: Akira OKAMOTO, Kanagawa (JP)

(73) Assignee: FUJIFILM Business Innovation Corp., Tokyo (JP)

(21) Appl. No.: 17/701,701

(22) Filed: Mar. 23, 2022

(30) Foreign Application Priority Data
Sep. 7, 2021 (JP) 2021-145378

(51) Int. Cl. G06F 3/12

(52) U.S. Cl. CPC G06F 3/1238; G06F 3/1222; G06F 3/1288

(57) ABSTRACT

An image processing device includes a processor configured to: generate, for each request, different device identification information according to the request; and register a virtual image processing device virtually indicating the virtual image processing device for each of the generated device identification information with respect to a server for an image processing service running on a network, the server being connected over the network to the image processing device to be used in the image processing service.

### CROSS-REFERENCE TO RELATED APPLICATIONS

This application is based on and claims priority under 35 USC 119 from Japanese Patent Application No. 2021-145378 filed Sep. 7, 2021.

### BACKGROUND

### (i) Technical Field

The present disclosure relates to an image processing device, an image processing method, and a non-transitory computer readable medium.

### (ii) Related Art

Japanese Unexamined Patent Application Publication No. 2020-187700 discloses a server for increasing convenience in the case of using multiple cloud print services. The server is a server that provides a first cloud print service, and includes a storage means that stores print data obtained from an external source, and a first transmission means that transmits a registration request to a second cloud print service different from the first cloud print service. In addition, the server includes an acquisition means that acquires print data from the second cloud print service registered on the basis of the registration request, and a second transmission means that transmits print data stored in the storage means to a printing device. Furthermore, the server is characterized in that the storage means is capable of storing print data acquired from the second cloud print service and print data received from an external source according to a different method from the second cloud print service.

### SUMMARY

Aspects of non-limiting embodiments of the present disclosure relate to registering multiple virtual image processing devices corresponding to a single image processing device in a server for an image processing service that runs on a network.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an image processing device including a processor configured to: generate, for each request, different device identification information according to the request; and register a virtual image processing device virtually indicating the virtual image processing device for each of the generated device identification information with respect to a server for an image processing service running on a network, the server being connected over the network to the image processing device to be used in the image processing service.

### BRIEF DESCRIPTION OF THE DRAWINGS

Exemplary embodiments of the present disclosure will be described in detail based on the following figures, wherein:

FIG. 1 is a block diagram illustrating an example of the configuration of an image processing system according to an exemplary embodiment;

FIG. 2 is a block diagram illustrating an example of a hardware configuration of an information processing device according to an exemplary embodiment;

FIG. 3 is a block diagram illustrating an example of a hardware configuration of a control unit of the image processing device according to an exemplary embodiment;

FIG. 4 is a block diagram illustrating an example of a functional configuration in the control unit of the image processing device according to an exemplary embodiment;

FIG. 5 is a schematic diagram illustrating an example of a configuration of a virtual printer management information database according to an exemplary embodiment;

FIG. 6 is a schematic diagram illustrating an example of a configuration of a user management information database according to an exemplary embodiment;

FIG. 7 is a flowchart illustrating an example of a first registration process according to an exemplary embodiment;

FIG. 8 is a front view illustrating an example of a user information input screen according to the exemplary embodiment;

FIG. 9 is a flowchart illustrating an example of a second registration process according to an exemplary embodiment;

FIG. 10 is a flowchart illustrating an example of a printing process according to a first exemplary embodiment;

FIG. 11 is a flowchart illustrating an example of a printing process according to a second exemplary embodiment; and

FIG. 12 is a flowchart illustrating an example of a printing process according to a third exemplary embodiment.

### DETAILED DESCRIPTION

Hereinafter, exemplary embodiments for carrying out the present disclosure will be described in detail and with reference to the drawings. Note that the exemplary embodiments describe the case of applying the present disclosure to an image processing system that provides a cloud print service in which a single image processing device in a single shared office is shared by multiple companies and used as a virtual printer (corresponding to a “virtual image processing device” of the present disclosure). A typical example of the “cloud print service” referred to herein is the cloud-supported “Universal Print” service provided by Microsoft Corporation. By using the service, it is possible to print using the image processing device in the cloud, even from a terminal device that is outside the office and unable to connect to the network where the image processing device is installed.

### First Exemplary Embodiment

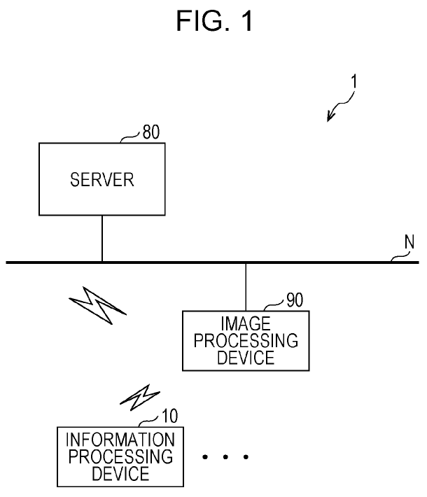

First, FIG. 1 will be referenced to describe a configuration of an image processing system 1 according to the first exemplary embodiment. FIG. 1 is a block diagram illustrating an example of the configuration of the image processing system 1 according to the present exemplary embodiment.

As illustrated in FIG. 1, the image processing system 1 according to the present exemplary embodiment includes a server 80, which is a cloud server used in a cloud print service as one type of image processing service, and a single image processing device 90 provided in the shared office described above.

Examples of the server 80 include an information processing device such as a personal computer or a server computer. Also, in the present exemplary embodiment, a digital multi-function device including functions such as an image printing function, an image reading function, and an image transmitting function is applied as the image processing device 90. However, the image processing device 90 is not limited to the above, and another image processing device, such as an image processing device including only an image printing function or an image processing device including only an image printing function and an image reading function, may also be applied as the image processing device 90.

The server 80 and the image processing device 90 are connected through a network N, and the server 80 is capable of bidirectional communication with the image processing device 90 through the network N. Note that in the present exemplary embodiment, a public communication channel such as the Internet or the telephone network is applied as the network N, but the network N is not limited thereto. For example, an internal corporate communication channel such as a local area network (LAN) or a wide area network (WAN), or a combination of an internal corporate communication channel and a public communication channel may also be applied as the network N. Additionally, in the present exemplary embodiment, a wired communication channel is applied as the network N, but the network N is not limited thereto. A wireless communication channel or a combination of wired and wireless communication channels may also be applied as the network N.

On the other hand, as illustrated in FIG. 1, the image processing system 1 according to the present exemplary embodiment includes an information processing device 10 configured as a mobile terminal respectively carried by users, including an administrator of the image processing system 1, belonging to each company that uses the shared office described above. Note that although a smartphone is applied as the information processing device 10 in the present exemplary embodiment, the information processing device 10 is not limited thereto. For example, another type of mobile device such as a mobile phone, a laptop personal computer, or a mobile information terminal device may also be applied as the information processing device 10. Moreover, a stationary information processing device such as a personal computer or a server computer may also be applied as the information processing device 10.

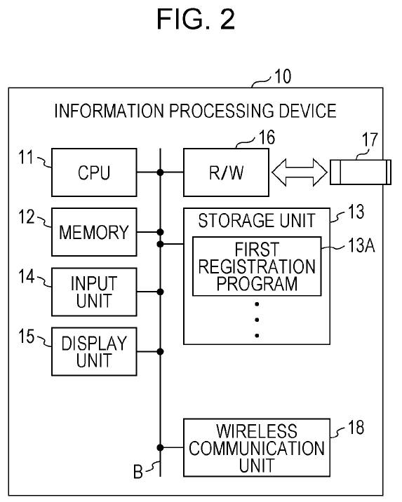

Next, FIG. 2 will be referenced to describe the configuration of the information processing device 10 according to the present exemplary embodiment. FIG. 2 is a block diagram illustrating an example of a hardware configuration of the information processing device 10 according to the present exemplary embodiment.

As illustrated in FIG. 2, the information processing device 10 according to the present exemplary embodiment is provided with a central processing unit (CPU) 11 that acts as a processor, a memory 12 that acts as a temporary storage area, a non-volatile storage unit 13, an input unit 14 such as a touch panel, a display unit 15 such as a liquid crystal display, a media reading and writing device (R/W) 16, and a wireless communication unit 18. The CPU 11, memory 12, storage unit 13, input unit 14, display unit 15, media reading and writing device 16, and wireless communication unit 18 are interconnected through a bus B. The media reading and writing device 16 reads out information written to a recording medium 17 and also writes information to the recording medium 17.

The storage unit 13 is achieved with a hard disk drive (HDD), a solid-state drive (SSD), flash memory, or the like. A first registration program 13A is stored in the storage unit 13, which acts as a storage medium. The first registration program 13A is stored in the storage unit 13 by connecting the recording medium 17 with the first registration program 13A written thereto to the media reading and writing device 16 and causing the media reading and writing device 16 to read out the first registration program 13A from the recording medium 17. The CPU 11 reads out and loads the first registration program 13A from the storage unit 13 into the memory 12, and sequentially executes processes included in the first registration program 13A.

In addition, the wireless communication unit 18 according to the present exemplary embodiment is capable of wireless communication with the server 80 over the network N. In the wireless communication unit 18 according to the present exemplary embodiment, a communication standard such as what is called 4G or 5G is applied as the communication standard for communication with the server 80, but obviously the communication standard is not limited thereto.

Furthermore, the wireless communication unit 18 according to the present exemplary embodiment may also wirelessly communicate with the image processing device 90 directly. In the wireless communication unit 18 according to the present exemplary embodiment, Bluetooth (registered trademark) is applied as the communication standard for communication with the image processing device 90, but the communication standard is not limited thereto. For example, any communication standard, such as Wi-Fi (registered trademark) or LAN in addition to Bluetooth (registered trademark), is applicable as the standard for communication with the image processing device 90 insofar as the communication standard makes it possible to communicate with the image processing device 90.

Note that, although not illustrated in the drawings, the information processing device 10 obviously may also be provided with other components for achieving the functions of a smartphone, such as a microphone that picks up speech uttered by the user.

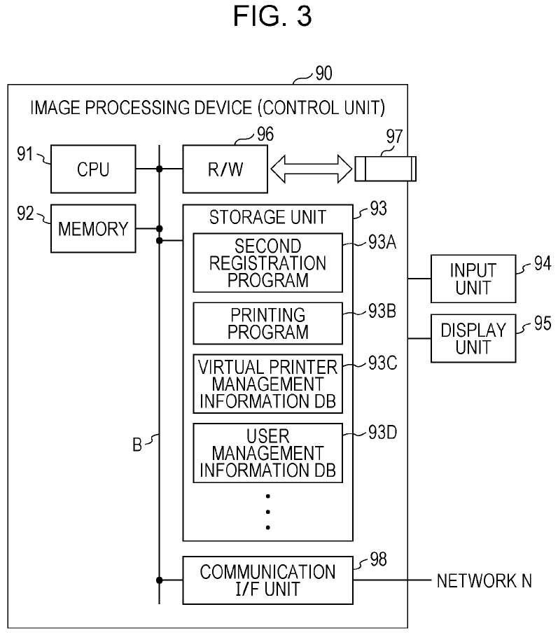

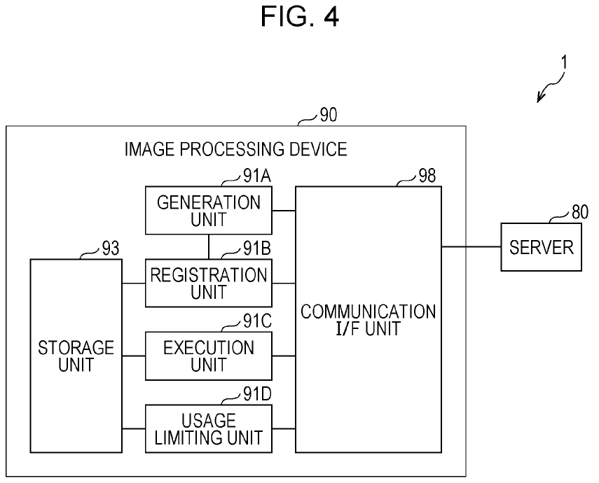

Next, FIGS. 3 and 4 will be referenced to describe the configuration of the image processing device 90 according to the present exemplary embodiment. FIG. 3 is a block diagram illustrating an example of a hardware configuration of a control unit in the image processing device 90 according to the present exemplary embodiment, and FIG. 4 is a block diagram illustrating an example of a functional configuration in the control unit of the image processing device 90 according to the present exemplary embodiment.

As illustrated in FIG. 3, the image processing device 90 according to the present exemplary embodiment is provided with a CPU 91 that acts as a processor, a memory 92 that acts as a temporary storage area, a non-volatile storage unit 93, a media reading and writing device (R/W) 96, and a communication interface (I/F) unit 98. The CPU 91, the memory 92, the storage unit 93, the media reading and writing device 96, and the communication I/F unit 98 are interconnected through a bus B. The media reading and writing device 96 reads out information written to a recording medium 97 and also writes information to the recording medium 97.

The storage unit 93 according to the present exemplary embodiment is achieved with an HDD, an SSD, flash memory, or the like. A second registration program 93A and a printing program 93B are stored in the storage unit 93, which acts as a storage medium. The second registration program 93A and the printing program 93B are stored in the storage unit 93 by connecting the recording medium 97 with the programs written thereto to the media reading and writing device 96 and causing the media reading and writing device 96 to read out each program from the recording medium 97. The CPU 91 successively reads out and loads each of the second registration program 93A and the printing program 93B from the storage unit 93 into the memory 92, and sequentially executes processes included in each program.

Additionally, a virtual printer management information database 93C and a user management information database 93D are stored in the storage unit 93. Details about these databases will be described later.

On the other hand, the communication I/F unit 98 according to the present exemplary embodiment communicates with the server 80 over the network N.

Note that, although not illustrated in the drawings, the image processing device 90 obviously is provided with components such as a wireless communication unit that performs the wireless communication described above with the information processing device 10, an image processing engine for achieving the image printing function, and a scanner unit for achieving the image reading function.

Next, FIG. 4 will be referenced to describe a functional configuration of the control unit of the image processing device 90 according to the present exemplary embodiment. As illustrated in FIG. 4, the image processing device 90 includes a generation unit 91A, a registration unit 91B, an execution unit 91C, and a usage limiting unit 91D. By executing the second registration program 93A and the printing program 93B, the CPU 91 of the image processing device 90 functions as the generation unit 91A, the registration unit 91B, the execution unit 91C, and the usage limiting unit 91D.

The generation unit 91A according to the present exemplary embodiment generates, for each request, different device identification information according to the request.

In other words, as described above, the image processing system 1 according to the present exemplary embodiment is configured to provide a cloud print service, and when the cloud print service is used, a virtual printer corresponding to the image processing device 90 is created on the server 80. Also, when the cloud print service is used, an identifier referred to as a universally unique identifier (UUID) is typically set in correspondence with the image processing device 90. Accordingly, in the image processing system 1 according to the present exemplary embodiment, the identifier is applied as the above device identification information.

In addition, the registration unit 91B according to the present exemplary embodiment registers, in the server 80, a virtual printer virtually indicating itself for each of the generated device identification information (in the present exemplary embodiment, a UUID, hereinafter referred to as the “identifier”).

Also, in the case where multiple virtual printers are registered, the execution unit 91C according to the present exemplary embodiment executes polling, which is a process of periodically querying each of the multiple registered virtual printers. Furthermore, the usage limiting unit 91D according to the present exemplary embodiment uses user management information, in which users who are able to use each of the multiple virtual printers registered in the server 80 are registered, to narrow down the virtual printers that are usable by each user.

Note that in the present exemplary embodiment, authentication information for each virtual printer is registered in the user management information, and the usage limiting unit 91D allows a corresponding virtual printer to be used if a user is authenticated using the authentication information. Also, in the present exemplary embodiment, when a virtual printer is registered by the registration unit 91B, the user requesting the registration of the virtual printer is registered in the user management information as a user who is able to use the virtual printer.

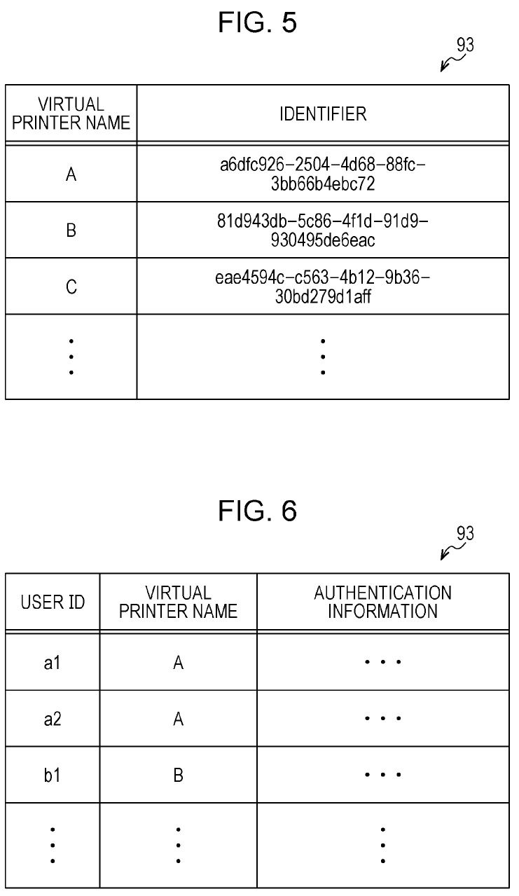

Next, FIG. 5 will be referenced to describe the virtual printer management information database 93C according to the present exemplary embodiment. FIG. 5 is a schematic diagram illustrating an example of a configuration of the virtual printer management information database 93C according to the present exemplary embodiment.

The virtual printer management information database 93C according to the present exemplary embodiment is a database in which information related to the virtual printers described above is registered, and as illustrated in FIG. 5 as one example, information indicating a virtual printer name and information indicating an identifier are stored in association with each other for each virtual printer.

The virtual printer name is information indicating a name of a virtual printer assigned to each virtual printer to specify the corresponding virtual printer. Also, the identifier is information indicating the identifier described above that is assigned to the corresponding virtual printer.

Next, FIG. 6 will be referenced to describe the user management information database 93D according to the present exemplary embodiment. FIG. 6 is a schematic diagram illustrating an example of a configuration of the user management information database 93D according to the present exemplary embodiment.

The user management information database 93D according to the present exemplary embodiment is a database in which information related to users of the image processing system 1 is registered, and as illustrated in FIG. 6 as one example, information indicating a user identification (ID), information indicating a virtual printer name, and information indicating authentication information are stored in association with each other for each user.

The user ID is preassigned information that is different for each user to individually identify the corresponding user. Also, the virtual printer name is the same information as the virtual printer name in the virtual printer management information database 93C, and the authentication information is preset information for authenticating the corresponding user.

Note that in the present exemplary embodiment, information that is different for each user is set as the authentication information, but the authentication information is not limited thereto, and the authentication information may also be set for each of predetermined groups, such as for each company or each division within a company, for example. Also, in the present exemplary embodiment, a pair of information identifying the user and a password is applied as the authentication information, but obviously the authentication information is not limited to this configuration.

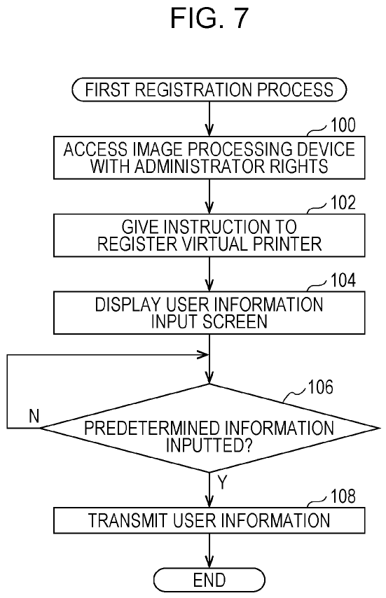

Next, FIGS. 7 to 10 will be referenced to describe operations by the image processing system 1 according to the present exemplary embodiment.

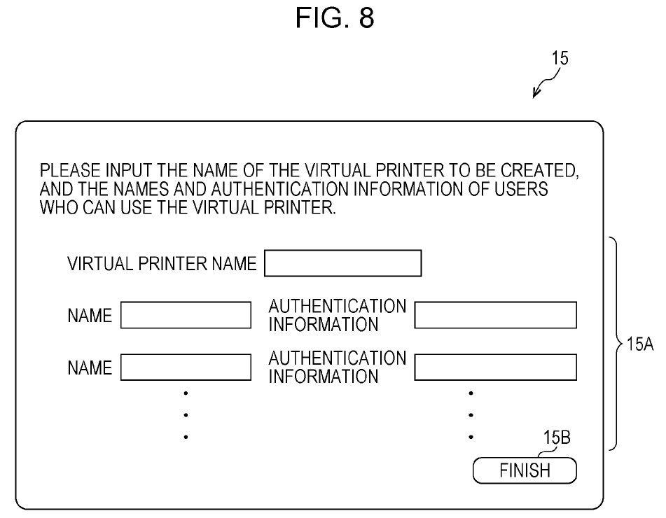

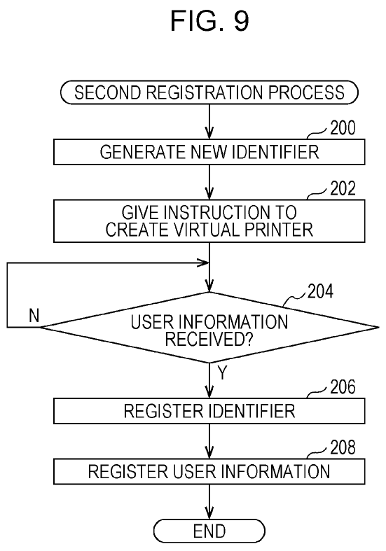

First, FIGS. 7 to 9 will be referenced to describe operations by the image processing system 1 when a virtual printer is registered. FIG. 7 is a flowchart illustrating an example of a first registration process according to the present exemplary embodiment. Also, FIG. 8 is a front view illustrating an example of a user information input screen according to the present exemplary embodiment. Moreover, FIG. 9 is a flowchart illustrating an example of a second registration process according to the present exemplary embodiment.

In the image processing system 1 according to the present exemplary embodiment, when an administrator of the image processing system 1 for each company that uses the shared office supplies input instructing the administrator’s own information processing device 10 to execute the first registration process, the CPU 11 of the information processing device 10 executes the first registration program 13A, thereby causing the first registration process illustrated in FIG. 7 to be executed.

In step 100 of FIG. 7, the CPU 11 accesses the image processing device 90 with administrator rights. In step 102, the CPU 11 transmits instruction information instructing the image processing device 90 to register a virtual printer (hereinafter referred to as “virtual printer registration instruction information”) to the image processing device 90. The image processing device 90 receiving the virtual printer registration instruction information generates an identifier that is different for each company and instructs the server 80 to create a virtual printer as described later.

In step 104, the CPU 11 controls the display unit 15 to display a user information input screen having a predetermined configuration, and in step 106, the CPU 11 stands by until predetermined information is inputted. FIG. 8 illustrates an example of the user information input screen according to the present exemplary embodiment.

As illustrated in FIG. 8, a message prompting the user to input a name for the virtual printer to be created and the name and authentication information of the users who will be able to use the virtual printer is displayed on the user information input screen according to the present exemplary embodiment. Also, an input area 15A for inputting the name of the virtual printer (hereinafter referred to as the “virtual printer name”), and the name and authentication information of the user is displayed on the user information input screen according to the present exemplary embodiment.

The user, who is an administrator, uses the input unit 14 to input information indicating the virtual printer name and the name and authentication information of each user who will be able to use the virtual printer into the corresponding input area 15A on the user information input screen, and then specifies a Finish button 15B. When the Finish button 15B is specified, a positive determination is return in step 106, and the flow proceeds to step 108.

In step 108, the CPU 11 transmits the information indicating the virtual printer name (hereinafter referred to as the “virtual printer name information”) and the name and authentication information of each user (hereinafter referred to as the “user information”) inputted on the user information input screen to the image processing device 90, and then ends the first registration process. Note that in step 108, the CPU 11 also includes the name and authentication information of the administrator him- or herself in the user information transmitted to the image processing device 90. At this point, information pre-registered separately by the administrator him- or herself or the like is used as the name and authentication information of the administrator.

Next, FIG. 9 will be referenced to describe operations by the image processing device 90 in the case of executing the second registration process according to the present exemplary embodiment. When the image processing device 90 receives the virtual printer registration instruction information described above from the information processing device 10 possessed by the administrator of the image processing system 1 for each company that uses the shared office, the CPU 91 of the image processing device 90 executes the second registration program 93A and thereby causes the second registration process illustrated in FIG. 9 to be executed.

In step 200 of FIG. 9, the CPU 91 generates a new identifier (the UUID described above) that has not been generated before. In step 202, the CPU 91 transmits instruction information for creating a new virtual printer (hereinafter referred to as the “virtual printer creation instruction information”), including the generated identifier, to the server 80. The server 80 receiving the virtual printer creation instruction information creates a new virtual printer in association with the received identifier.

In step 204, the CPU 91 stands by until the virtual printer name information and user information described above is received, and in step 206, the CPU 91 stores (registers) information indicating the received virtual printer name information and generated identifier in the virtual printer management information database 93C. In step 208, the CPU 91 stores (registers) the received virtual printer name information and user information in the user management information database 93D, and then ends the second registration process.

By executing the first registration process and the second registration process above according to an instruction from the administrator of each company that uses the shared office, the virtual printer management information database 93C and the user management information database 93D illustrated by way of example in FIGS. 5 and 6 are constructed.

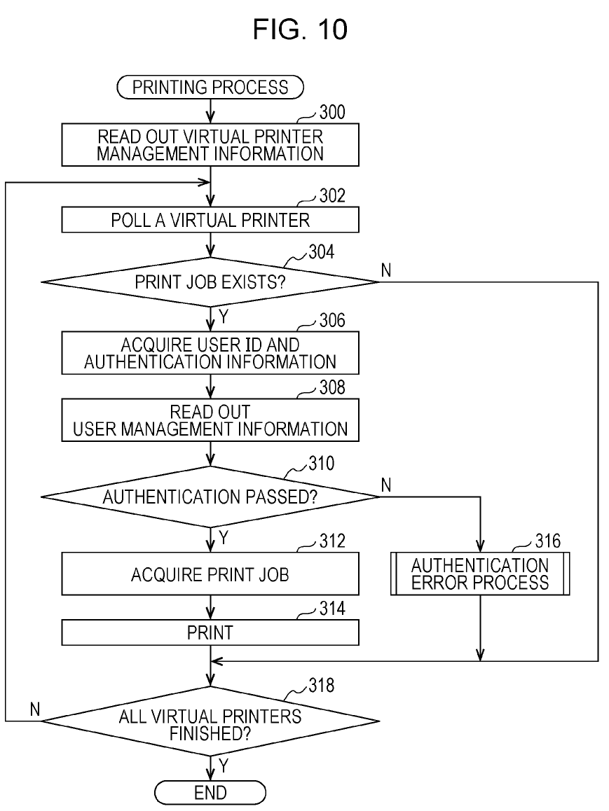

Next, FIG. 10 will be referenced to describe operations by the image processing device 90 in the case of executing the printing process according to the present exemplary embodiment.

In the image processing system 1 according to the present exemplary embodiment, when a user registered in the user management information database 93D uses a virtual printer to print, the user executes a dedicated application program installed in the user’s own information processing device 10. When executing the application program, the user inputs the user ID and authentication information set with respect to the user him- or herself. By executing the application program, a print job to be printed is held together with the user ID and authentication information inputted by the user in the corresponding virtual printer created on the server 80. Note that if the user uses a web browser application program installed in the user’s own information processing device 10 to access the server 80 and input the user ID and authentication information on a displayed screen for inputting the user ID and authentication, the virtual printer usable by the user may be displayed, and by selecting and giving a print instruction to the displayed virtual printer and uploading data to be printed, the print job to be printed may be held together with the user ID and authentication information inputted by the user in the corresponding virtual printer created on the server 80.

In the above state, the printing process illustrated in FIG. 10 is executed by causing the CPU 91 of the image processing device 90 according to the present exemplary embodiment execute the printing program 93B on a predetermined interval (one minute in the present exemplary embodiment).

In step 300 of FIG. 10, the CPU 91 reads out all of the information from the virtual printer management information database 93C (hereinafter referred to as the “virtual printer management information”). In step 302, the CPU 91 polls any one virtual printer (hereinafter referred to as the “virtual printer to be processed”) for which information is included in the read-out virtual printer management information.

In step 304, the CPU 91 determines whether or not the virtual printer to be processed is holding a print job. If the determination is negative, the flow proceeds to step 318, whereas if the determination is positive, the flow proceeds to step 306.

In step 306, the CPU 91 acquires, from the virtual printer to be processed, the user ID and authentication information corresponding to the print job determined to be held in the virtual printer to be processed. In step 308, the CPU 91 reads out the authentication information corresponding to the acquired user ID from the user management information database 93D.

In step 310, the CPU 91 determines whether or not the authentication information acquired from the virtual printer to be processed matches the authentication information read out from the user management information database 93D, and thereby determines whether or not authentication is successful for the user performing the printing process with respect to the virtual printer to be processed. In the case of a positive determination result, the flow proceeds to step 312.

In step 312, the CPU 91 acquires the print job from the virtual printer to be processed, and in step 314, the CPU 91 executes the printing process on the basis of document data to be printed and print settings information included in the acquired print job. Thereafter, the flow proceeds to step 318.

On the other hand, if the determination in step 310 is negative, or in other words, if authentication is unsuccessful, the flow proceeds to step 316, and a predetermined authentication error process is executed. Thereafter, the flow proceeds to step 318. Note that in the present exemplary embodiment, a process of transmitting information indicating that authentication was unsuccessful to the information processing device 10 possessed by the user corresponding to the acquired user ID is applied as the above authentication error process, but obviously the authentication error process is not limited thereto.

In step 318, the CPU 91 determines whether or not the processes from steps 302 to 316 have been executed for all virtual printers for which information is included in the read-out virtual printer management information. If the determination is negative, the flow returns to step 302, whereas if the determination is positive, the printing process ends. Note that when repeating the process from steps 302 to 318, the CPU 91 treats a virtual printer that has not been processed yet as the virtual printer to be processed.

### Second Exemplary Embodiment

The overall configuration of the image processing system 1 according to the present exemplary embodiment and the hardware configurations of the information processing device 10 and the image processing device 90 are similar to the image processing system 1 according to the first exemplary embodiment, and consequently a description is omitted here.

First, a functional configuration in the control unit of the image processing device 90 according to the present exemplary embodiment will be described. In the functional configuration in the control unit of the image processing device 90 according to the present exemplary embodiment, only the operations of the execution unit 91C are different from the execution unit 91C according to the first exemplary embodiment.

Namely, the execution unit 91C according to the present exemplary embodiment narrows down the virtual printers to be polled according to a predetermined condition. More particularly, the execution unit 91C according to the present exemplary embodiment applies a condition specifying a virtual printer corresponding to a user who is present in the area where the image processing device 90 is installed (in the present exemplary embodiment, the shared office) as the above condition.

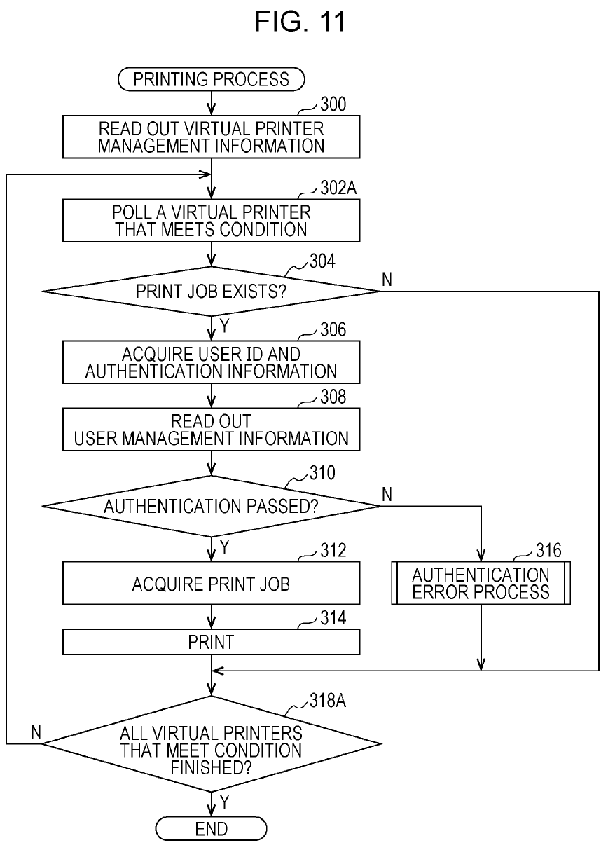

Hereinafter, FIG. 11 will be referenced to describe operations by the image processing device 90 in the case of executing a printing process according to the present exemplary embodiment as the operations of the image processing system 1 according to the present exemplary embodiment. FIG. 11 is a flowchart illustrating an example of the printing process according to the present exemplary embodiment. Note that in FIG. 11, steps for performing the same processes as the printing process illustrated in FIG. 10 are denoted by the same step numbers, and a description of such steps is omitted.

As illustrated in FIG. 11, the printing process according to the present exemplary embodiment differs from the printing process according to the first exemplary embodiment in that the process of step 302A is applied instead of the process of step 302, and the process of step 318A is applied instead of the process of step 318.

Namely, in step 302A, the CPU 91 polls any one virtual printer for which information is included in the read-out virtual printer management information and which also matches a predetermined condition. In the present exemplary embodiment, as described above, a condition specifying a virtual printer corresponding to a user who is present in the shared office is applied as the predetermined condition.

In other words, in the shared office according to the present exemplary embodiment, the attendance of users who use the shared office and also use the image processing device 90 is managed by an attendance management system, and the attendance management system is capable of specifying a user who is present in the shared office. Furthermore, the image processing device 90 is connected to the attendance management system, and the image processing device 90 is also capable of specifying a user who is present in the shared office.

Accordingly, in step 302A, the CPU 91 uses the above attendance management system to specify the user ID of a user who is present in the shared office, and references the user management information database 93D to specify a virtual printer corresponding to the specified user ID. Thereafter, the CPU 91 polls only the specified virtual printer.

After that, in step 318A, the CPU 91 determines whether or not the processes from steps 302A to 316 have been executed for all virtual printers for which information is included in the read-out virtual printer management information and which also match the predetermined condition. If the determination is negative, the flow returns to step 302A, whereas if the determination is positive, the printing process ends. Note that when repeating the process from steps 302A to 318A, the CPU 91 treats a virtual printer which matches the predetermined condition and which has not been processed yet as the virtual printer to be processed.

Note that although the present exemplary embodiment describes a case of applying a condition specifying a virtual printer corresponding to a user who is present in the area where the image processing device 90 is installed as the predetermined condition, the predetermined condition is not limited to the above configuration. For example, a condition specifying a virtual printer narrowed down according to frequency of use may also be applied as the predetermined condition. As one configuration example for the above case, a history of printing using the image processing device 90 by each of the companies that use the shared office is recorded, weekdays and time periods with a high frequency of use are estimated, and the virtual printers to be polled are narrowed down for each company according to the frequency of use.

Also, the present exemplary embodiment describes a case of using an attendance management system to specify a user who is present in the shared office, but the configuration is not limited thereto. For example, a user who is present in the shared office may also be specified by monitoring communication packets on a network such as a LAN set up in the shared office.

### Third Exemplary Embodiment

The overall configuration of the image processing system 1 according to the present exemplary embodiment and the hardware configurations of the information processing device 10 and the image processing device 90 are similar to the image processing system 1 according to the first exemplary embodiment, and consequently a description is omitted here.

First, a functional configuration in the control unit of the image processing device 90 according to the present exemplary embodiment will be described. In the functional configuration in the control unit of the image processing device 90 according to the present exemplary embodiment, only the operations of the execution unit 91C are different from the execution unit 91C according to the first exemplary embodiment.

Namely, the execution unit 91C according to the present exemplary embodiment narrows down the virtual printers to be polled according to a predetermined condition. In particular, the execution unit 91C according to the present exemplary embodiment applies a condition specifying a virtual printer corresponding to a user who is logged in to the virtual printer itself as the above condition.

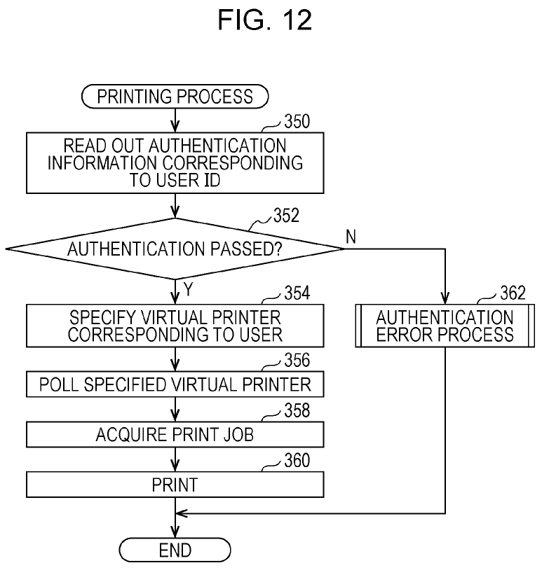

Hereinafter, FIG. 12 will be referenced to describe operations by the image processing device 90 in the case of executing a printing process according to the present exemplary embodiment as the operations of the image processing system 1 according to the present exemplary embodiment. FIG. 12 is a flowchart illustrating an example of the printing process according to the present exemplary embodiment.

In the present exemplary embodiment, when a user uses a usable virtual printer, the user logs in to the image processing device 90 using the user ID and authentication information set with respect to the user him- or herself, and uses the application program described above to perform desired printing. With this arrangement, a print job corresponding to the above printing is held in the corresponding virtual printer.

The CPU 91 of the image processing device 90 according to the present exemplary embodiment executes the printing program 93B when the user logs in as above, thereby causing the printing process illustrated in FIG. 12 to be executed.

In step 350 of FIG. 12, the CPU 91 reads out the authentication information corresponding to the user ID inputted during login from the user management information database 93D.

In step 352, the CPU 91 determines whether or not the authentication information inputted during login matches the read-out authentication information, and thereby determines whether or not authentication is successful for the user performing the printing process with respect to the virtual printer. In the case of a positive determination result, the flow proceeds to step 354.

In step 354, the CPU 91 specifies a virtual printer to be processed (hereinafter referred to as the “specific virtual printer”) by reading out the virtual printer name corresponding to the user ID inputted during login from the user management information database 93D. Additionally, the CPU 91 reads out the identifier corresponding to the specific virtual printer from the virtual printer management information database 93C.

In step 356, the CPU 91 uses the read-out identifier to poll the specific virtual printer. In step 358, the CPU 91 acquires the print job from the specific virtual printer, and in step 360, the CPU 91 executes the printing process according to the acquired print job. Thereafter, the printing process ends.

On the other hand, if the determination in step 352 is negative, or in other words, if authentication is unsuccessful, the flow proceeds to step 362, and a predetermined authentication error process is executed. Thereafter, the printing process ends. Note that in the present exemplary embodiment, a process of transmitting information indicating that authentication was unsuccessful to the information processing device 10 possessed by the user corresponding to the acquired user ID is applied as the above authentication error process, but obviously the authentication error process is not limited thereto.

Note that although the exemplary embodiments above describe a case of applying the present disclosure to a cloud print service, the configuration is not limited thereto. For example, the present disclosure may also be applied to a print service that does not use a cloud server, such as a print service that uses a network server or the like inside an organization, for example.

Also, the exemplary embodiments above describe a where the virtual printer management information database 93C and the user management information database 93D are registered in the image processing device 90, but the configuration is not limited thereto. For example, each database may also be registered in a device accessible by the image processing device 90, such as the server 80.

Moreover, although the exemplary embodiments above describe a case of applying a cloud print service as an example of an image processing service according to the present disclosure, the image processing service is not limited thereto. For example, a service that executes a process of altering or transferring image data may also be applied as the image processing service. A virtual image processing device corresponding to the functions provided in the image processing device 90, such as the image reading function and the image transmitting function provided in the image processing device 90, may also be registered in the server 80. For example, in the case where a virtual character recognition device is registered as the virtual image processing device, it is possible to transmit image data read by the image processing device 90 to the virtual character recognition device and perform a character recognition process on the image data in the server 80, while during this time, the image processing device 90 polls the virtual character recognition device, and when a character recognition result is generated, the image processing device 90 acquires the generated character recognition result.

The foregoing describes exemplary embodiments, but the technical scope of the present disclosure is not limited to the scope described in the exemplary embodiments above. Various modifications or alterations may be made to the exemplary embodiments above within a scope that does not depart from the gist of the present disclosure, and any embodiments obtained by such modifications or alterations are also included in the technical scope of the present disclosure.

Furthermore, the exemplary embodiments above do not limit the present disclosure as stated in the claims, and not all combinations of features described in the exemplary embodiments are necessarily required as means for addressing the issues of the present disclosure. The exemplary embodiments described above include various levels of disclosure, and the various disclosures are elicited through the combination of the multiple structural elements disclosed herein. Even if several structural elements are removed from among all of the structural elements illustrated in the exemplary embodiments, the configuration with the several structural elements removed therefrom may still be elicited as an disclosure insofar as an effect is obtained.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Furthermore, the exemplary embodiments above describe a case in which various processes are achieved by a software configuration using a computer by executing a program, but the present disclosure is not limited thereto. For example, the various processes may also be achieved by a hardware configuration, or by a combination of a hardware configuration and a software configuration.

Otherwise, the configuration of the image processing system 1 described in the above exemplary embodiments is an example, and obviously, unnecessary portions may be removed or new portions may be added within a scope that does not depart from the gist of the present disclosure.

Also, the flows of the various processes described in the exemplary embodiments above are an example, and obviously, unnecessary steps may be removed, new steps may be added, or the processing sequence may be rearranged within a scope that does not depart from the gist of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image processing device comprising:
a processor configured to:
generate, for each request, different device identification information according to the request; and
register a virtual image processing device indicating the virtual image processing device for each of the generated device identification information with respect to a server for an image processing service running on a network, the server being connected over the network to the image processing device to be used in the image processing service.

2. The image processing device according to claim 1, wherein, in a case where a plurality of virtual image processing devices have been registered, the processor is configured to poll each of the plurality of registered virtual image processing devices.

3. The image processing device according to claim 2, wherein the processor is configured to narrow down the virtual image processing device to be polled according to a predetermined condition.

4. The image processing device according to claim 3, wherein the condition is a condition specifying the virtual image processing device corresponding to a user who is logged in to the virtual image processing device itself.

5. The image processing device according to claim 3, wherein the condition is a condition specifying the virtual image processing device narrowed down according to a frequency of use of the virtual image processing device itself.

6. The image processing device according to claim 3, wherein the condition is a condition specifying the virtual image processing device corresponding to a user who is present in an area where the image processing device is installed.

7. The image processing device according to claim 1, wherein the processor is configured to use user management information, in which users who are able to use each of the plurality of virtual image processing devices registered in the server are registered, to narrow down the virtual image processing device that is usable by each user.

8. The image processing device according to claim 2, wherein the processor is configured to use user management information, in which users who are able to use each of the plurality of virtual image processing devices registered in the server are registered, to narrow down the virtual image processing device that is usable by each user.

9. The image processing device according to claim 3, wherein the processor is configured to use user management information, in which users who are able to use each of the plurality of virtual image processing devices registered in the server are registered, to narrow down the virtual image processing device that is usable by each user.

10. The image processing device according to claim 4, wherein the processor is configured to use user management information, in which users who are able to use each of the plurality of virtual image processing devices registered in the server are registered, to narrow down the virtual image processing device that is usable by each user.

11. The image processing device according to claim 5, wherein the processor is configured to use user management information, in which users who are able to use each of the plurality of virtual image processing devices registered in the server are registered, to narrow down the virtual image processing device that is usable by each user.

12. The image processing device according to claim 6, wherein the processor is configured to use user management information, in which users who are able to use each of the plurality of virtual image processing devices registered in the server are registered, to narrow down the virtual image processing device that is usable by each user.

13. The image processing device according to claim 7, wherein:
in the user management information, authentication information is registered for each virtual image processing device, and
the processor is configured to allow the use of the virtual image processing device if authentication using the corresponding authentication information is successful.

14. The image processing device according to claim 8, wherein:
in the user management information, authentication information is registered for each virtual image processing device, and
the processor is configured to allow the use of the virtual image processing device if authentication using the corresponding authentication information is successful.

15. The image processing device according to claim 9, wherein:
in the user management information, authentication information is registered for each virtual image processing device, and
the processor is configured to allow the use of the virtual image processing device if authentication using the corresponding authentication information is successful.

16. The image processing device according to claim 10, wherein:
in the user management information, authentication information is registered for each virtual image processing device, and
the processor is configured to allow the use of the virtual image processing device if authentication using the corresponding authentication information is successful.

17. The image processing device according to claim 13, wherein, in the user management information, authentication information is registered for each virtual image processing device and also for each user.

18. The image processing device according to claim 7, wherein in a case of registering the virtual image processing device, the processor is configured to register a user requesting registration of the virtual image processing device in the user management information as a user who is able to use the virtual image processing device.

19. An image processing method comprising:
generating, for each request, different device identification information according to the request; and
registering a virtual image processing device virtually indicating an image processing device for each of the generated device identification information with respect to a server for an image processing service running on a network, the server being connected over the network to the image processing device to be used in the image processing service.

20. A non-transitory computer readable medium storing a program causing a computer to execute a process for registration, the process comprising:
generating, for each request, different device identification information according to the request; and
registering a virtual image processing device virtually indicating an image processing device for each of the generated device identification information with respect to a server for an image processing service running on a network, the server being connected over the network to the image processing device to be used in the image processing service.
